(19) United States
(12) Patent Application Publication
(10) Pub. No.: US 2026/0151288 A1
(43) Pub. Date: Jun. 4, 2026

(54) PASSIVE COLLAPSE MOUNTING STRUCTURE FOR SHOULDER MASSAGE MODULE

(71) Applicant: Adient (Chongqing) Automotive Components Co., Ltd., Chongqing (CN)

(72) Inventors: Jun XU, Chongqing (CN); Yi XIN, Chongqing (CN); Shaobin XU, Chongqing (CN); Wei JIA, Chongqing (CN); Muxing TAN, Chongqing (CN)

(21) Appl. No.: 19/400,090

(22) Filed: Nov. 25, 2025

(30) Foreign Application Priority Data
Nov. 29, 2024 (CN) 202411736900.2

(51) Int. Cl. A61H 7/00; B60N 2/90

(52) U.S. Cl. CPC A61H 7/00; B60N 2/976; A61H 2201/0149; A61H 2201/1215; A61H 2201/1614; A61H 2203/0431; A61H 2205/062

(57) ABSTRACT

A passive collapse mounting structure for a shoulder massage module may have a seat back and a shoulder support rotatably mounted at a shoulder position of the seat back. An elastic element may be provided between the shoulder support and the seat back. The elastic element may apply a thrust to flip the shoulder support forward relative to the seat back. A driving mechanism may be provided between the shoulder support and the seat back. The driving mechanism may be configured to actively control the shoulder support to rotate and fold backward against the resistance of the elastic element. When the shoulder support is in a forward-unfolded state, a thrust from an occupant's shoulder may be able to force the shoulder support to passively rotate and fold backward against the resistance of the elastic element.

### TECHNICAL FIELD

The device relates to the technical field of vehicle seats, and specifically to a passive collapse mounting structure for a shoulder massage module.

### BACKGROUND

In today's society, vehicles are one of the most important means of transportation. As people's living standards improve, they have higher expectations for the comfort of vehicle interiors. Passengers, in particular, are prone to fatigue and discomfort from maintaining the same posture for extended periods during long journeys.

Vehicle seats with shoulder massage functions are one of the products designed to ensure passenger comfort. In the prior art, although the shoulder massage seats on the market can massage the passenger's shoulders, most of the shoulder massage devices are fixedly mounted as a whole, which cannot meet the needs of occupants with different body sizes. Although a small number of shoulder massage devices are mounted on the seat back by means of a synchronizing rod, with its rotation controlled by an electric angle adjuster to adapt to the needs of occupants with different body sizes, the entire adjustment assembly lacks a collapse function. When a vehicle is subjected to a rearward impact force, the entire shoulder massage device cannot collapse rearward in time, thereby imposing a load on the occupant's shoulder and posing a great safety hazard.

### SUMMARY

In view of this, the device provides a passive collapse mounting structure for a shoulder massage module, which is intended to improve the safety of the shoulder support massage device.

To achieve the above objective, the technical solution is as follows:

A passive collapse mounting structure for a shoulder massage module, comprising a seat back and a shoulder support rotatably mounted at a shoulder position of the seat back, characterized in that: an elastic element is provided between the shoulder support and the seat back, the elastic element applies a thrust to flip the shoulder support forward relative to the seat back, a driving mechanism is provided between the shoulder support and the seat back, the driving mechanism is configured to actively control the shoulder support to rotate and fold backward against the resistance of the elastic element, and, when the shoulder support is in a forward-unfolded state, a thrust from an occupant's shoulder is able to force the shoulder support to passively rotate and fold backward against the resistance of the elastic element.

With the above structure, the provision of the driving mechanism allows the shoulder support to be in the folded state. When the driving mechanism is running, the thrust applied to the shoulder support by the elastic element can be released, so that the shoulder support is flipped forward to adapt to the needs of occupants with different body sizes for the shoulder support. The occupant's backward thrust can also cause the shoulder support to collapse backward, thereby reducing the impact force on the occupant when a vehicle is in a collision, and further ensuring the occupant's safety.

Preferably, the shoulder support is fixedly connected to a rearwardly extending swing arm, the elastic element is supported between the swing arm and the seat back, and the driving mechanism is able to pull the shoulder support to rotate backward through the swing arm. With this structure, the rotation of the shoulder support is more easily controlled through the connection between the driving mechanism and the swing arm.

Preferably, a distal end of the swing arm is provided with a groove having an opening facing upward, the driving mechanism comprises a first rotary electric motor fixedly disposed at a rear end of the seat back, an output end of the first rotary electric motor is connected to a first lead screw, the first lead screw is arranged along a height direction of the seat back, a first sliding block is threadedly mounted on the first lead screw, the first sliding block has a limiting post located within the groove, and, when the shoulder support is in a forward-unfolded state, a thrust from an occupant's shoulder is able to force the groove to move downward and separate from the limiting post. With the above structure, when the first sliding block moves upward along the first lead screw, it can release the pressure on the elastic element, thereby causing the elastic element to push the shoulder support to rotate forward. When the shoulder support is in the forward-unfolded state, the thrust from the occupant's shoulder can cause the groove to actively move downward and disengage from the limiting post, thereby forming a collapse.

Preferably, the elastic element is a pneumatic spring, two ends of which are supported on the swing arm and the first rotary electric motor, respectively. With the above structure, it is ensured that the elastic element can stably apply a forward rotational force to the shoulder support, while also providing a cushioning function when the shoulder support collapses, further ensuring the occupant's safety.

Preferably, the swing arm is provided with an elongated hole, the elongated hole extends along a thickness direction of the seat back, the driving mechanism comprises a second rotary electric motor rotatably disposed at the rear end of the seat back, an output end of the second rotary electric motor is connected to a second lead screw, the second lead screw is arranged along a thickness direction of the seat back, a second sliding block is threadedly mounted on the second lead screw, the second sliding block has a shaft pin movably disposed in the elongated hole, and, when the shoulder support is in the forward-unfolded state, the thrust from the occupant's shoulder is able to force the elongated hole to move backward relative to the shaft pin. With the above structure, when the second sliding block moves forward along the second lead screw, it can release the pressure applied to the elastic element, thereby causing the elastic element to push the shoulder support forward. Meanwhile, the second rotary electric motor rotates backward. When the shoulder support is in the forward-unfolded state, the thrust from the occupant's shoulder can cause the elongated hole to move backward relative to the shaft pin, that is, the second sliding block is forced to move from the rightmost end of the elongated hole to the leftmost end thereof, thereby forming a collapse.

Preferably, the elastic element is a spring, the swing arm has a downwardly extending mounting protrusion, a lower end of the spring abuts against the seat back, and an upper end of the spring is always fitted on the mounting protrusion. With the above structure, it allows the elastic element to continuously apply a forward rotational thrust to the shoulder support, while also providing a cushioning function when the shoulder support collapses, further ensuring the occupant's safety.

Preferably, a massage assembly is integrated inside the shoulder support. With the above structure, the massage of the occupant's shoulder can be implemented, relieving the occupant's shoulder fatigue.

Preferably, two driving mechanisms are provided, the two driving mechanisms are symmetrically distributed on left and right sides of the seat back, the two driving mechanisms are connected by a connecting plate, and two sides of a lower end of the shoulder support are rotatably disposed at two ends of the connecting plate. With the above structure, it allows for more stable rotation of the shoulder support.

Preferably, a lifting assembly is provided between the seat back and the shoulder support, the lifting assembly is configured to drive the shoulder support to move up and down relative to the seat back, the lifting assembly comprises a lifting electric motor, the lifting electric motor is disposed at a middle position of the seat back, an output end of the lifting electric motor is provided with a third lead screw, the third lead screw is arranged along a length direction of the seat back, and a middle portion of the connecting plate is threadedly mounted with the third lead screw. With the above structure, the height adjustment of the shoulder support can be realized.

Preferably, the driving mechanisms are disposed on the connecting plate. With the above structure, it can be ensured that the forward/backward rotation and upward/downward adjustment of the shoulder support do not interfere with each other.

Compared with the prior art, the device has the following beneficial effects:
1. With the passive collapse mounting structure of the shoulder massage module, the provision of the driving mechanism allows the shoulder support to be in the folded state. When the driving mechanism is running, the thrust applied to the shoulder support by the elastic element can be released, so that the shoulder support is flipped forward to adapt to the needs of occupants with different body sizes for the shoulder support. The occupant's backward thrust can also cause the shoulder support to collapse backward, thereby reducing the impact force on the occupant when a vehicle is in a collision, and further ensuring the occupant's safety.
2. The provision of the lifting assembly causes the shoulder support to further have a height adjustment function, further ensuring the needs of occupants with different body sizes.
3. Two collapse modes are provided, and an elastic element is equipped for each collapse mode, which can ensure that the shoulder support can slowly rotate backward when the vehicle is in a collision, thereby providing a cushioning function for the occupants, while also ensuring the service life of each lead screw.

### BRIEF DESCRIPTION OF THE DRAWINGS

FIG. 1 is a schematic structural view (front view) of a first type of vehicle seat;

FIG. 2 is a cross-sectional view of a shoulder support 2 in FIG. 1 when it is in a folded state (with a headrest hidden);

FIG. 3 is a cross-sectional view of the shoulder support 2 in FIG. 1 when it is in a forward-rotated state (with a headrest hidden);

FIG. 4 is a cross-sectional view of the shoulder support 2 in FIG. 1 when it is in a collapsed state (with a headrest hidden);

FIG. 5 is a schematic structural view (front view) of a second type of vehicle seat;

FIG. 6 is a cross-sectional view of a shoulder support 2 in FIG. 5 when it is in a folded state;

FIG. 7 is a cross-sectional view of the shoulder support 2 in FIG. 5 when it is in a forward-rotated state;

FIG. 8 is a cross-sectional view of the shoulder support 2 in FIG. 7 when it is in a raised state;

FIG. 9 is a cross-sectional view of the shoulder support 2 in FIG. 8 when it is in a collapsed state;

FIG. 10 is a partial enlarged view of FIG. 6;

FIG. 11 is a reference view of an actual use state of the shoulder support 2 in the folded state;

FIG. 12 is a reference view of an actual use state of a shoulder support 2 when it is raised upward and rotated forward.

### DETAILED DESCRIPTION

The device will be further described below with reference to the embodiments and drawings.

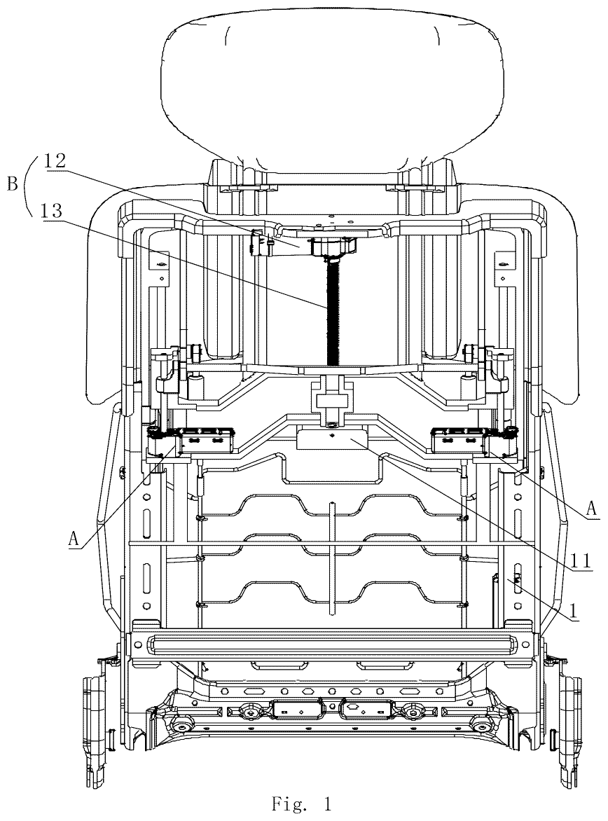

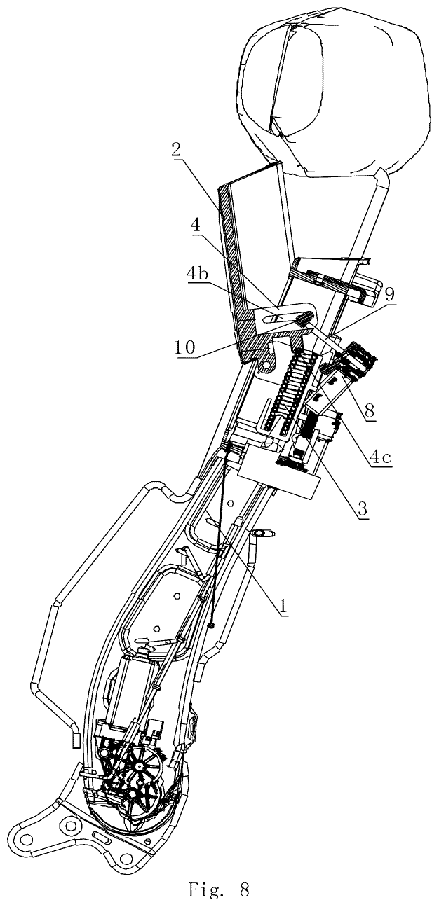

As shown in FIGS. 1 to 9, a passive collapsible mounting structure for a shoulder massage module comprises a seat back 1 and a shoulder support 2 rotatably mounted on a shoulder position of the seat back 1. In this embodiment, a massage assembly is integrated inside the shoulder support 2 to relieve an occupant's shoulder fatigue. An elastic element 3 is mounted between the shoulder support 2 and the seat back 1, and the elastic element 3 applies a thrust that causes the shoulder support 2 to flip forward relative to the seat back 1. A driving mechanism A is further provided between the shoulder support 2 and the seat back 1. The driving mechanism A is used to actively control the shoulder support 2 to rotate and fold backward against the resistance of the elastic element 3. When the shoulder support 2 is in a forward-unfolded state, a thrust from the occupant's shoulder can force the shoulder support 2 to passively rotate and fold backward against the resistance of the elastic element 3.

The driving mechanism A can cause the shoulder support 2 to be kept in a folded state. At this time, the elastic element 3 is compressed and stores energy. When the driving mechanism A is running, it can release the thrust of the elastic element 3 on the shoulder support 2, so that the shoulder support 2 rotates forward to meet the needs of occupants with different body sizes for the shoulder support 2. When the shoulder support 2 is in the forward-unfolded state, the thrust on the occupant's shoulder can cause the shoulder support 2 to rotate and fold backward against the resistance of the elastic element 3. The shoulder support can be passively collapsed by an external force. When a vehicle is in a collision, it can reduce the impact force on the occupant, thereby ensuring the occupant's safety.

In this embodiment, the shoulder support 2 is fixedly connected to a rearwardly extending swing arm 4, and the elastic element 3 is supported between the swing arm 4 and the seat back 1. The driving mechanism A can pull the shoulder support 2 to move backward through the swing arm 4.

Specifically, the present device provides the following two different connections for the rotating assembly A and the swing arm 4.

### Embodiment 1

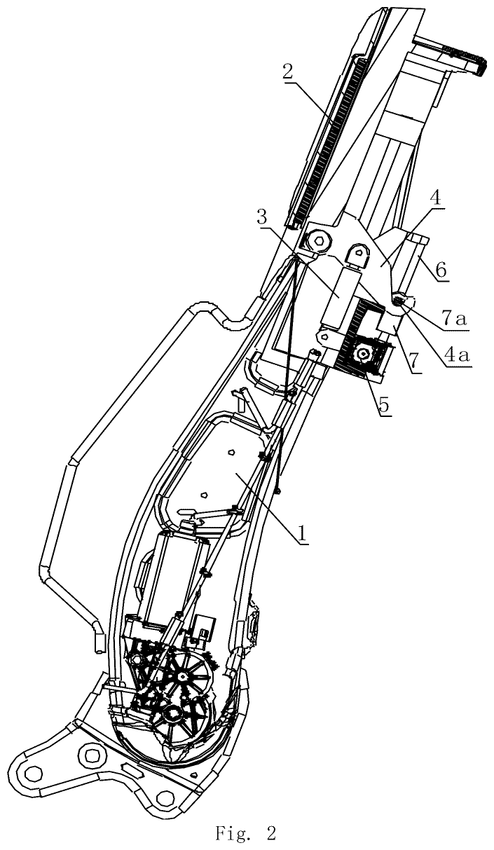

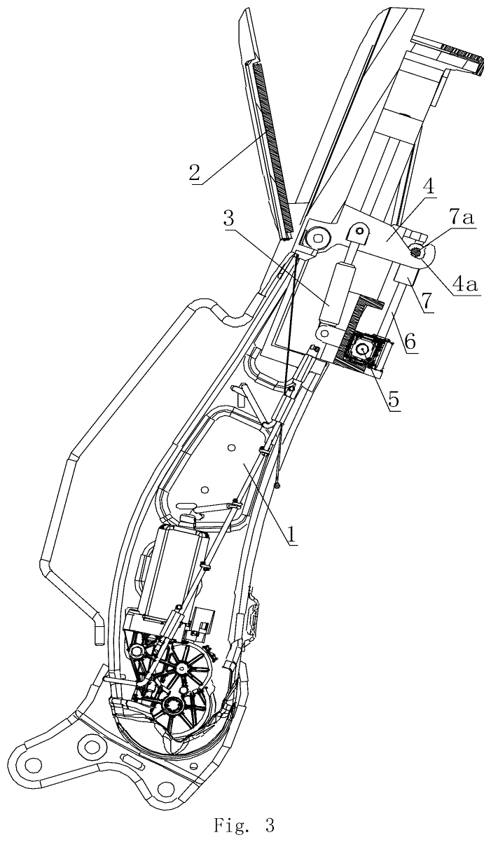

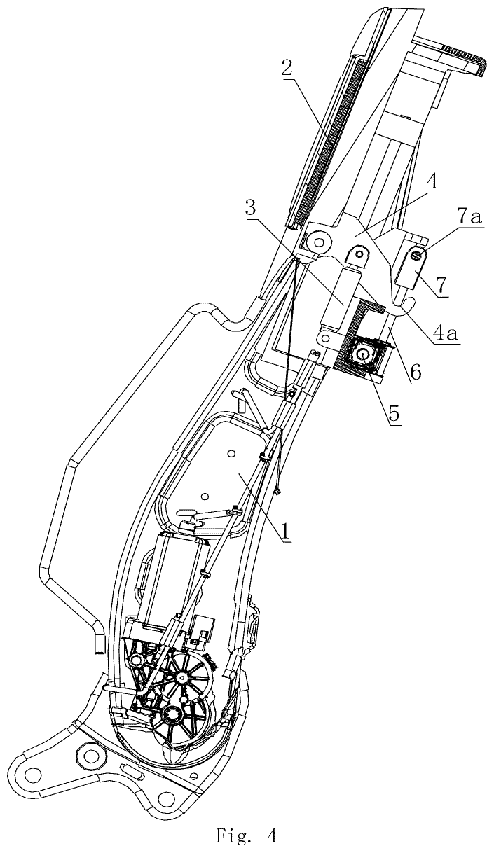

As shown in FIGS. 2 to 4, a groove 4a is formed at the end of the swing arm 4 away from the shoulder support, the groove 4a having an opening facing upward. The driving mechanism A comprises a first rotary electric motor 5 fixedly mounted at the rear end of the seat back 1. An output end of the first rotary electric motor 5 is connected to a first lead screw 6, and the first lead screw 6 is arranged along a fixed direction of the seat back 1. A first sliding block 7 is threadedly mounted on the first lead screw 6, and the first sliding block 7 has a limiting post 7a located within the groove 4a. With reference to FIGS. 2 and 3, when the shoulder support 2 is in a folded state, the first sliding block 7 is located at the bottommost end of the first lead screw 6, and the limiting post 7a is supported within the groove 4a. When the first rotary electric motor 5 runs and drives the first sliding block 7 to move upward along the first lead screw 6, it can release the thrust of the elastic element 3 on the shoulder support 2, enabling the shoulder support 2 to rotate forward to meet the needs of occupants with different body sizes for the shoulder support 2. During the upward movement of the first sliding block 7, the limiting post 7a always remains within the groove 4a. When the shoulder support 2 needs to rotate and fold backward, the first sliding block 7 moves downward and presses the swing arm 4 to move downward against the thrust of the elastic element 3. With reference to FIG. 4, when the shoulder support 2 is in the forward-unfolded state, the thrust from the occupant's shoulder can force the groove 4a to move downward and separate from the limiting post 7a, so that the shoulder support 2 collapses and folds backward. In addition, during the collapse process, it is ensured that the first lead screw 6 is not affected by the downward collapse force, thereby ensuring the service life of the first lead screw 6.

In this embodiment, the elastic element 3 is a pneumatic spring, two ends of which are rotatably connected to the middle position of the swing arm 4 and the base of the first rotary electric motor 5, respectively. Thus, it is ensured that the elastic element 3 stably applies an upward thrust to the swing arm 4, so as to ensure that the shoulder support 2 can rotate forward. In addition, the provision of the elastic element 3 can ensure that a cushioning function is provided when the shoulder support 2 collapses backward, further reducing the impact force on the occupant's shoulder and ensuring the occupant's safety.

In this embodiment, two driving mechanisms A are provided. The two driving mechanisms A are symmetrically distributed on the left and right sides of the seat back 1, and connected to each other by a connecting plate 11. Two sides of the lower end of the shoulder support 2 are rotatably mounted at two ends of the connecting plate 11. The design of the two driving mechanisms A makes the rotation of the shoulder support 2 more stable.

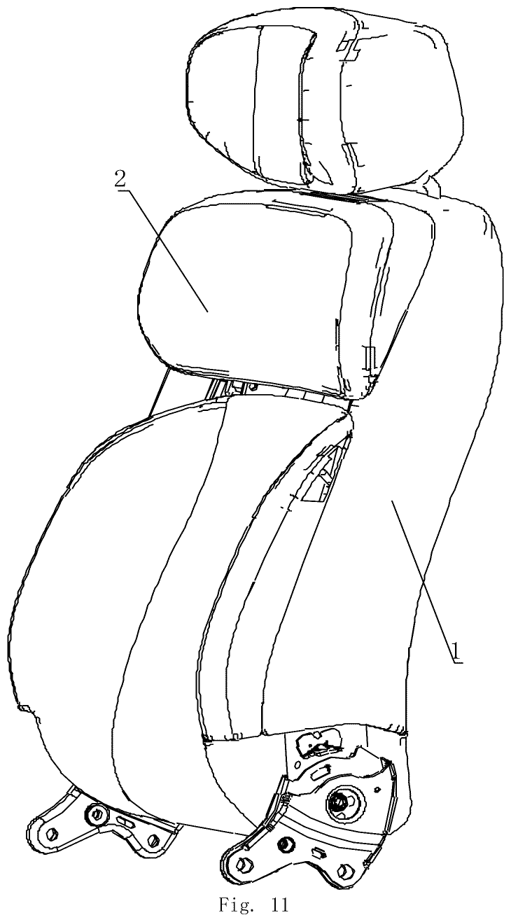

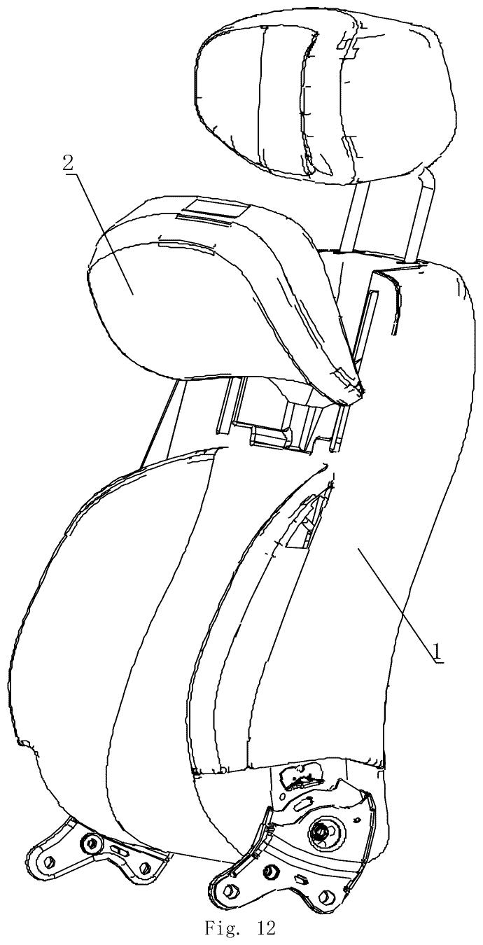

As shown in FIGS. 1, 11 and 12, a lifting assembly B is mounted between the seat back 1 and the shoulder support 2. The lifting assembly B is configured to drive the shoulder support 2 to move up and down relative to the seat back 1. The lifting assembly B comprises a lifting electric motor 12. In this embodiment, the lifting electric motor 12 is fixedly mounted in the middle position of the seat back 1. An output end of the lifting electric motor 12 is connected to a third lead screw 13. The third lead screw 13 is arranged along the length direction of the seat back 1. The middle position of the connecting plate 11 is threadedly mounted with the third lead screw 13. With such a design, the height adjustment of the shoulder support 2 can be realized, further adapting to the needs of occupants with different body sizes for the shoulder support 2.

Meanwhile, the first rotary electric motor 5 is fixedly mounted on the connecting plate 13, thereby ensuring that the forward and backward rotation and height adjustment of the shoulder support 2 do not interfere with each other.

### Embodiment 2

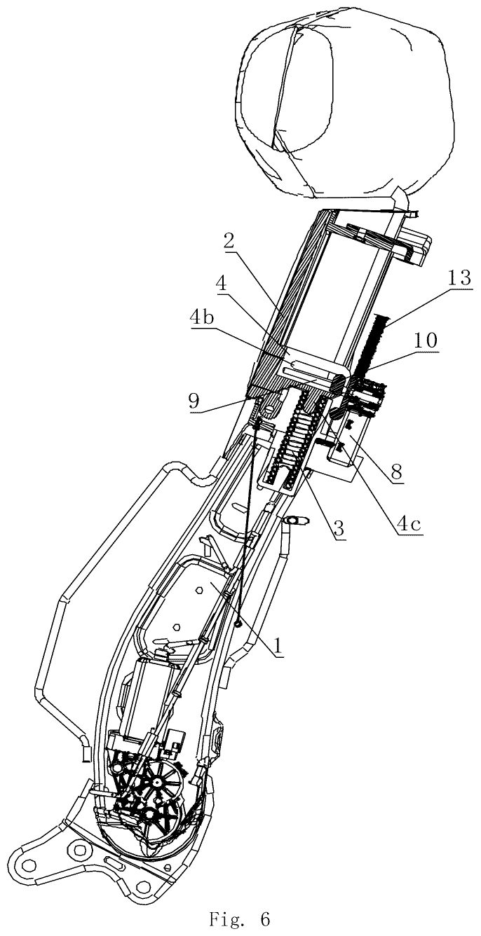

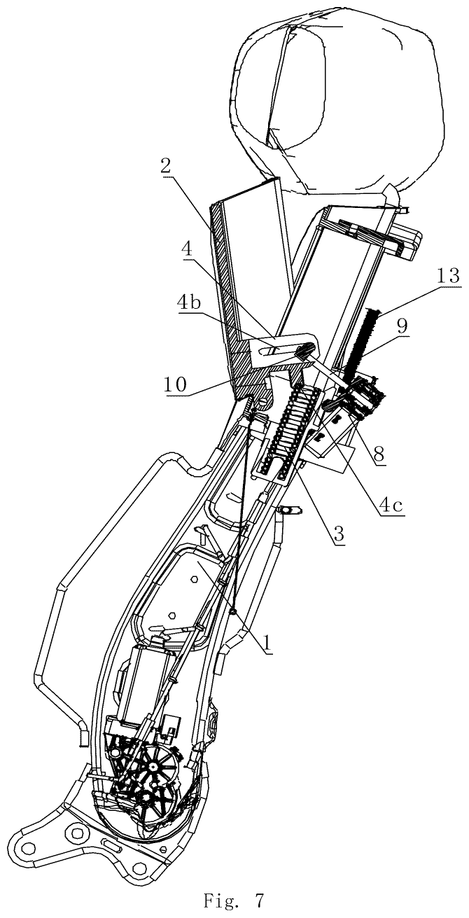

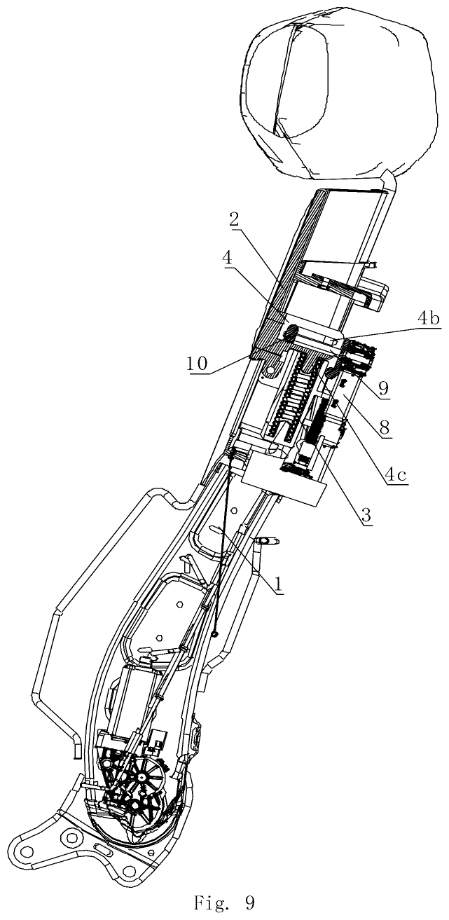

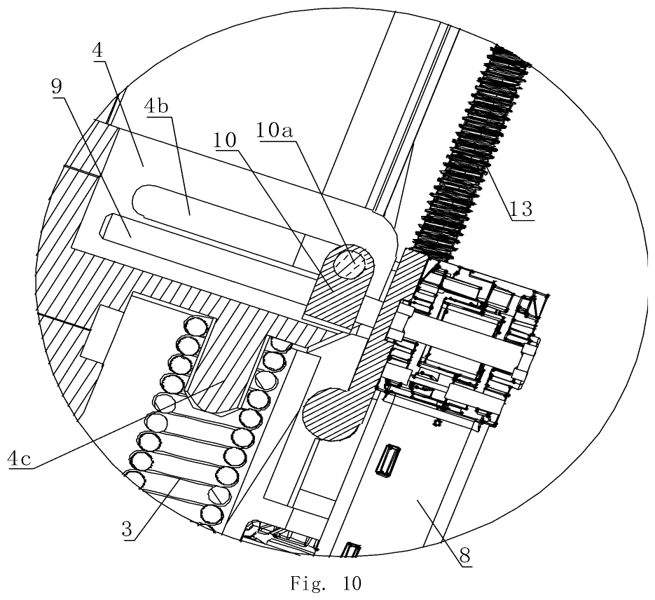

As shown in FIGS. 6 to 10, an elongated hole 4b is formed on the swing arm 4. The elongated hole 4 b extends along the thickness direction of the seat back 1. The driving mechanism A comprises a second rotary electric motor 8 rotatably disposed at the rear end of the seat back 1. An output end of the second rotary electric motor 8 is connected to a second lead screw 9. The second lead screw 9 is arranged along the thickness direction of the seat back 1. A second sliding block 10 is threadedly mounted on the second lead screw 9. The second sliding block 10 has a shaft pin 10a disposed in the elongated hole 4b. With reference to FIGS. 6 and 7, when the shoulder support 2 is in a folded state, the second sliding block 10 is located at the rearmost end of the elongated hole 4b, i.e., the rightmost end in FIG. 6. When the second rotary electric motor 8 runs and drives the second sliding block 10 to move forward along the second lead screw 9, the driving mechanism A releases the thrust of the elastic element 3 on the shoulder support 2, thereby pushing the shoulder support 2 to rotate forward to adapt to the needs of occupants with different body sizes for the shoulder support 2. Meanwhile, the second rotary electric motor 8 rotates toward the rear side of the seat back 1 to ensure that no motion interference is formed. Throughout the process, the second sliding block 10 is always located at the rearmost end of the elongated hole 4b, i.e., in the locked state as shown in FIG. 7. With reference to FIG. 9, when the shoulder support 2 is in a forward-unfolded state, the thrust from the occupant's shoulder can force the elongated hole 4b to move toward the second sliding block 10, i.e., the state shown in FIG. 9. The shoulder support 2 is in a fully collapsed and folded state. The second sliding block 10 is located at the foremost end of the elongated hole 4b. Meanwhile, the position of the second sliding block 10 on the second lead screw 9 remains unchanged. This ensures that the driving mechanism A is not affected during the entire collapse process, thereby ensuring the service life of the second lead screw 9.

In this embodiment, the elastic element 3 is a spring, and is arranged along the length direction of the seat back 1. The swing arm 4 has a downwardly extending mounting protrusion 4c. The lower end of the spring is fixed against the vehicle seat, and the upper end thereof is always fitted onto the mounting protrusion 4c. This design can stably apply an upward thrust to the swing arm 4, thereby enabling the shoulder support 2 to rotate forward. Meanwhile, when the shoulder support 2 collapses backward, the elastic element 3 can further buffer the impact force on the occupant's shoulder, thereby ensuring the occupant's riding safety.

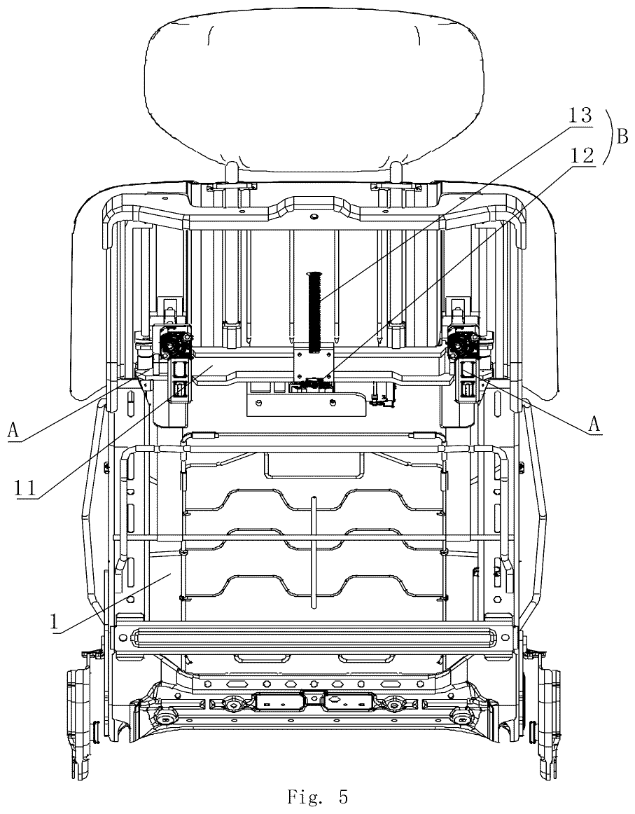

As shown in FIG. 5, in this embodiment, similarly, two driving mechanisms A are provided, and are symmetrically distributed on the left and right sides of the seat back 1. The two driving mechanisms A are also connected by a connecting plate 11. The middle portion of the connecting plate 11 is threadedly mounted with the third lead screw 13, so as to ensure that the shoulder support 2 has both forward and backward rotation and height adjustment functions.

Meanwhile, the second rotary electric motor 8 and the elastic element 3 are both fixedly mounted on the connecting plate 13 to ensure that there is no motion interference between the driving mechanism A and the lifting assembly B.

Finally, it should be noted that only preferred embodiments have been described above. Those of ordinary skill in the art can make various similar expressions without departing from the spirit and claims, and such changes all fall within the scope of protection.

What is claimed is:

1. A passive collapse mounting structure for a shoulder massage module, comprising: a seat back and a shoulder support rotatably mounted at a shoulder position of the seat back, characterized in that: an elastic element is provided between the shoulder support and the seat back, the elastic element applies a thrust to flip the shoulder support forward relative to the seat back, a driving mechanism is provided between the shoulder support and the seat back, the driving mechanism is configured to actively control the shoulder support to rotate and fold backward against the resistance of the elastic element;
when the shoulder support is in a forward-unfolded state, a thrust from an occupant's shoulder is able to force the shoulder support to passively rotate and fold backward against the resistance of the elastic element.

2. The passive collapse mounting structure for the shoulder massage module according to claim 1, characterized in that: the shoulder support is fixedly connected to a rearwardly extending swing arm, the elastic element is supported between the swing arm and the seat back, and the driving mechanism is able to pull the shoulder support to rotate backward through the swing arm.

3. The passive collapse mounting structure for the shoulder massage module according to claim 2, characterized in that: a distal end of the swing arm is provided with a groove having an opening facing upward, the driving mechanism comprises a first rotary electric motor fixedly disposed at a rear end of the seat back, an output end of the first rotary electric motor is connected to a first lead screw, the first lead screw is arranged along a height direction of the seat back, a first sliding block is threadedly mounted on the first lead screw, the first sliding block has a limiting post located within the groove;
when the shoulder support is in a forward-unfolded state, a thrust from an occupant's shoulder is able to force the groove to move downward and separate from the limiting post.

4. The passive collapse mounting structure for the shoulder massage module according to claim 3, characterized in that: the elastic element is a pneumatic spring, two ends of which are supported on the swing arm and the first rotary electric motor, respectively.

5. The passive collapse mounting structure for the shoulder massage module according to claim 2, characterized in that: the swing arm is provided with an elongated hole, the elongated hole extends along a thickness direction of the seat back, the driving mechanism comprises a second rotary electric motor rotatably disposed at the rear end of the seat back, an output end of the second rotary electric motor is connected to a second lead screw, the second lead screw is arranged along a thickness direction of the seat back, a second sliding block is threadedly mounted on the second lead screw, the second sliding block has a shaft pin movably disposed in the elongated hole; and
when the shoulder support is in the forward-unfolded state, the thrust from the occupant's shoulder is able to force the elongated hole to move backward relative to the shaft pin.

6. The passive collapse mounting structure for the shoulder massage module according to claim 5, characterized in that: the elastic element is a spring, the swing arm has a downwardly extending mounting protrusion, a lower end of the spring abuts against the seat back, and an upper end of the spring is always fitted on the mounting protrusion.

7. The passive collapse mounting structure for the shoulder massage module according to claim 1, characterized in that: a massage assembly is integrated inside the shoulder support.

8. The passive collapse mounting structure for the shoulder massage module according to claim 2, characterized in that: two driving mechanisms are provided, the two driving mechanisms are symmetrically distributed on left and right sides of the seat back, the two driving mechanisms are connected by a connecting plate, and two sides of a lower end of the shoulder support are rotatably disposed at two ends of the connecting plate.

9. The passive collapse mounting structure for the shoulder massage module according to claim 8, characterized in that: a lifting assembly is provided between the seat back and the shoulder support, the lifting assembly is configured to drive the shoulder support to move up and down relative to the seat back, the lifting assembly comprises a lifting electric motor, the lifting electric motor is disposed at a middle position of the seat back, an output end of the lifting electric motor is provided with a third lead screw, the third lead screw is arranged along a length direction of the seat back, and a middle portion of the connecting plate is threadedly mounted with the third lead screw.

10. The passive collapse mounting structure for the shoulder massage module according to claim 9, characterized in that: the driving mechanisms are disposed on the connecting plate.
